(19) United States
(12) Patent Application Publication
(10) Pub. No.: US 2012/0077063 A1
(43) Pub. Date: Mar. 29, 2012

(54) ELECTRICAL SYSTEM

(76) Inventors: Peter SCHUETZBACH, Moeglingen (DE); Andreas Netz, Ludwigsburg (DE); Armin Glock, Urbach (DE)

(21) Appl. No.: 13/228,029

(22) Filed: Sep. 8, 2011

(30) Foreign Application Priority Data
Sep. 20, 2010 (DE) 102010041017.9

(51) Int. Cl. H01M 2/40

(52) U.S. Cl. 429/81

(57) ABSTRACT

An electrical system, including an energy storage, in particular an electrochemical energy storage, has at least one cell having an anode, a cathode, and a fluid electrolyte, which allows a current flow from the anode to the cathode. The cell has at least two openings, the openings being connected by a connector for the circulatory conveyance of the electrolyte. The safety and the longevity of an energy storage are improved in this way.

### FIELD OF THE INVENTION

The present invention relates to an electrical system. The present invention relates in particular to an electrical system including an energy storage, in particular an electrochemical energy storage, such as a lithium-ion battery.

### BACKGROUND INFORMATION

The use of energy storages, in particular electrochemical energy storages, is currently widespread. In particular the use of lithium-ion batteries has manifold advantages, since they are typically thermally stable and have no memory effect. In addition, such energy storages are distinguished by a comparatively high energy density.

Various concepts are known for improving the safety and longevity of such energy storages.

An electrochemical energy storage is described in German Patent Application No. DE 10 2007 023 896. This energy storage is used in particular for enlarging the temperature range in which it may be safely and reliably operated. For this purpose, the energy storage includes at least two storage chambers, for receiving one electrolyte each, or at least one storage chamber for receiving a component of an electrolyte. The storage chambers are provided for receiving various electrolytes or various components of the electrolyte for various operating states. It is thus possible, on the one hand, if the storage containers each contain one electrolyte, to initially pump the electrolyte contained in the energy storage into one of the storage accumulators (chambers) and to subsequently fill the energy storage with another electrolyte from a second storage container. If the storage container only contains one component of the electrolyte, this component is added or removed according to the temperature at which the electrochemical energy storage is operated.

A system for homogenizing a material concentration of an electrolyte in a cell of a battery is described in German Patent No. DE 20 2006 011 287 U1. The system includes a charging device for charging the battery and a circulating device for circulating the electrolyte. The circulating device may include a pump to circulate the electrolyte within the battery, which causes electrolyte homogenization. The circulating device may be insertable into the battery through an opening which is situated in a cover of a housing. A simpler charging procedure, which is also optimized with respect to charging time and charging energy, may be achieved by this system.

### SUMMARY OF THE INVENTION

An object of the present invention is to provide an electrical system, including an energy storage, in particular an electrochemical energy storage, which has at least one cell having an anode, a cathode, and a fluid electrolyte, which allows a current flow from the anode to the cathode. It is provided according to the present invention that the cell has at least two openings, the openings being connected by a connector for the circulatory conveyance of the electrolyte.

Through the system according to the present invention, an energy storage is provided, through which an electrolyte may flow and in which a chemical and physical intervention in the cell from the outside is thus made possible.

Flowing through the cell allows thorough mixing of the electrolyte, for example. Because of this, for example, material changes of the electrolyte are not locally delimited, but rather are distributed in the entire electrolyte. Homogenization of the electrolyte is therefore possible. A comparable electrolyte is provided on average at every point of the electrode, which optimizes the performance of the energy storage. In particular, the charging procedure may be significantly improved in this way.

In addition, it is possible according to the present invention to be able to perform manifold different interventions in the cell. Possible changes or incorrect sequences within the energy storage may thus be reacted to in manifold ways, which always ensures controlled operation of the energy storage at the optimum of its performance. Furthermore, the service life of an energy storage according to the present invention may be significantly extended and safety-critical states may often already be reduced or remedied entirely before they represent an actual danger.

An ability to flow through the cell or the energy storage also allows a pressure regulation within the cell. A pressure drop in the event of increased pressure in the cell as a result of heating in the cell is thus possible, for example. For this purpose, it is particularly preferred if the connector is fluidically connected to a pressure compensation container.

Within the scope of an advantageous embodiment of the system according to the present invention, the connector is situated outside the energy storage. In this case, the system according to the present invention may be manufactured particularly easily, no complex retrofitting work being required on conventional energy storages. In addition, some of the refinements described hereafter may be executed particularly easily in this specific embodiment.

Within the scope of a further advantageous embodiment of the system according to the present invention, the connector is fluidically connected to a pump for conveying the electrolyte. It is thus possible to convey the electrolyte in a particularly simple and reliable way. In addition, permanent conveyance of the electrolyte may thus be implemented, or time-limited conveyance is possible without the occurrence of a delay.

Within the scope of a further advantageous embodiment of the system according to the present invention, a closure device for closing the connector is situated in the connector. In this way, it is possible for the energy storage to be able to operate safely and reliably during normal operation, without a replacement or through-flow of the electrolyte taking place. The closure device may include a valve or multiple valves, for example, which close the connector fluid-tight and may be situated adjacent to the openings. Furthermore, it may be advantageous within the scope of the present invention if the closure device is only permeable in one flow direction. In this way, the conveyance of the electrolyte in a circuit may be ensured. For this purpose, the closure device may have a check valve, for example, which lets the electrolyte pass in a predefined direction, for example, triggered by an electrolyte pressure achieved by a pump. Conveyance of the electrolyte in the opposite direction is thereby suppressed.

In a further preferred embodiment of the system according to the present invention, the connector is fluidically connected to an opening, which is closable airtight, for introducing and/or discharging at least one substance. In this embodiment, it is possible in particular to introduce components of the electrolyte therein or replace them or to replace the entire electrolyte. The electrolyte may thus be adapted to the desired operating conditions. For example, the electrolyte may be changed from a winter-specific composition to a summer-specific composition, or vice versa, to thus allow operation optimized to high or low temperatures.

In addition, it is thus possible to allow regeneration of the electrodes in the cell. For example, active materials may be introduced into the electrolyte, which reach the electrodes by flowing through the cell with the electrolyte and accumulate there and may thus regenerate the electrodes. In this way, the service life of the electrodes and thus of the entire energy storage may be significantly extended.

It is thus possible not to replace the entire energy storage at the end of the service life of the electrolyte, for example. Rather, the service life of the entire energy storage may be extended without great expenditure by a comparatively simple replacement of the electrolyte. In addition, through the provision of the opening on the connector, it is possible to replace the electrolyte in an oxygen-free and water-free environment, so that no harmful substances may reach the interior of the cell, which could damage the energy storage in the long term.

Furthermore, this embodiment is advantageous since the cell may be purged when it threatens to go out of control. In this case, a chemical intervention may further be made, in that a liquid, such as an inert liquid or a liquid having corresponding reactive agents, is conveyed into the cell.

In a further advantageous embodiment of the system according to the present invention, the connector is fluidically connected to an analysis unit. In this way, the electrolyte may be extremely precisely chemically and physically analyzed, which allows an immediate reaction to a change of the composition or another condition, for example, with respect to the contents or the conductance of the electrolyte. Permanent monitoring of the electrolyte is therefore possible, which allows conclusions to be drawn about the conditions prevailing in the cell and possibly undesirable sequences and/or decomposition products. A change within the cell may thus often be recognized already well before the occurrence of a safety-critical or safety-questionable situation, which allows an immediate reaction thereto. In addition, aging effects may be effectively counteracted in this way. The safety and the longevity of an energy storage in a system according to the present invention may thus be improved.

Within the scope of a further advantageous embodiment of the system according to the present invention, the connector is fluidically connected to a gas separator. It is thus possible to remove gas bubbles from the cell which arise in the cell during conveyance of the electrolyte through the connector. The active area of the electrodes may thus be enlarged, which may increase the performance of the cell and furthermore may extend the service life.

Within the scope of a further advantageous embodiment of the system according to the present invention, the system has a temperature control unit for temperature control of the electrolyte. The temperature control unit may advantageously include a heating device and/or a cooling device, using which the electrolyte may be heated or cooled. The electrolyte may thus not only be adapted to different ambient temperatures by a material change, but rather the temperature of the electrolyte may furthermore be adjusted permanently, so that operation at greatly varying temperatures is possible even if the electrolyte is not optimized.

This is advantageous in particular because the temperature range of conventional energy storages, for example, of lithium-ion batteries, is limited both at low temperatures and also at elevated temperatures. This may be disadvantageous in particular for applications in motor vehicles, since the temperatures of the energy storages may reach the limits or go beyond them in the event of long shutdown times in winter or in summer. This may result in significant power losses of the energy storage and harmful secondary reactions may occur, which drastically shorten the service life of the electrochemical energy storage. In addition, a significant deviation of the electrolyte temperature beyond the temperature limits may result in safety-relevant problems, for example, a thermal runaway. It is significant that the electrolyte in particular is responsible for the limits within which an energy storage is to be operated.

In addition, protection from local overheating may thus be provided. Both the service life and also the safety may thus be significantly improved.

Within the scope of a further advantageous embodiment of the system according to the present invention, at least one channel for the targeted guiding of the electrolyte is provided in the cell. The electrolyte may thus be guided as desired along the electrodes or the separator by a channel in the interior of the cell, whereby the performance of the energy storage may be developed in a defined way. In addition, it may be ensured that a sufficient quantity of electrolyte always washes around the electrodes or the separator.

A further advantage of this embodiment is in the filling of the cell, since areas of the cell which are more difficult to access are also reached rapidly and possibly contained gas bubbles may be discharged more easily.

It is particularly preferred that the channel is formed by a delimitation made of comb-like intermeshing structures, which is situated on the surface of the anode, the cathode, and/or the separator. A particularly large contact area between the separator and the electrodes and the electrolyte is thus ensured. The channel may be structured in an active material situated on the surface of the electrodes, for example.

### BRIEF DESCRIPTION OF THE DRAWINGS

FIG. 1 shows a schematic sectional view of a system according to the present invention from the side.

FIG. 2 shows a schematic sectional view of an energy storage for a system according to the present invention diagonally from above.

### DETAILED DESCRIPTION

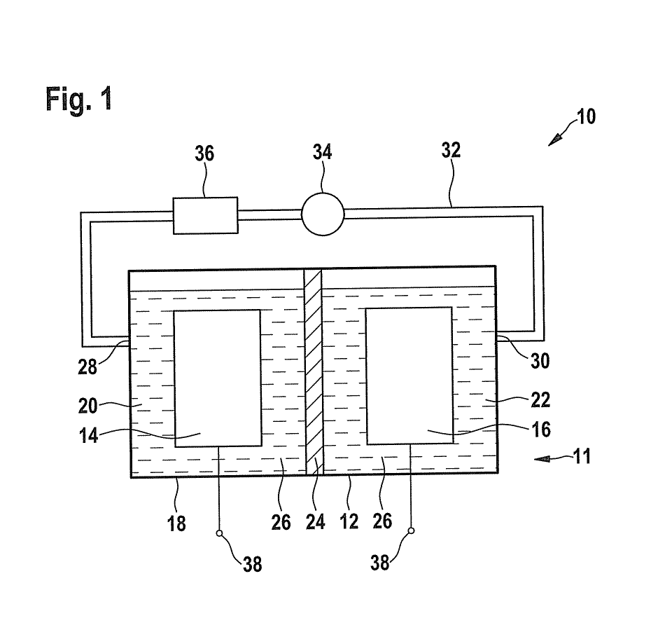

FIG. 1 shows a schematic sectional view of a system 10 according to the present invention having an energy storage 11 from the side. Energy storage 11 is an electrochemical energy storage in particular, such as a lithium-ion battery. Energy storage 11 includes at least one, preferably multiple cells 12, each of which represents a galvanic unit. Current is generated in each cell 12 by an electrochemical reaction. For this purpose, cell 12 includes at least one anode 14 and one cathode 16, which are advantageously situated in a housing 18 in an anode chamber 20 or a cathode chamber 22, respectively. Anode 14 and cathode 16 or anode chamber 20 and cathode chamber 22 are separated from one another by a separator 24.

If energy storage 11 is a lithium-ion battery, anode 14 includes an intercalation compound based on carbon, an alloy of lithium with tin and/or silicon, optionally also in a carbon matrix, and metallic lithium or lithium titanate, for example. Cathode 16 may also be a typical cathode for lithium-ion batteries in this case. Suitable materials for cathode 16 are, for example, lithium cobalt oxide, lithium nickel oxide, lithium cobalt nickel oxide, lithium nickel cobalt manganese oxide, lithium nickel cobalt aluminum oxide, lithium iron oxide, lithium manganese dioxide, lithium manganese oxide, and mixed oxides of lithium manganese oxide, lithium iron phosphate, lithium manganese phosphate, lithium cobalt phosphate, and lithium nickel phosphate. Furthermore, suitable active materials are possible on the cathode side, for example, typical transition metal oxides, in particular lithium cobalt oxide, lithium nickel oxide, lithium manganese oxide, and mixtures thereof.

Any arbitrary separator known to those skilled in the art as is used in lithium-ion batteries is also suitable as separator 24. Separator 24 is typically a semipermeable diaphragm which is permeable to lithium ions. For example, polypropylene, polyethylene, fluorinated hydrocarbons, hydrocarbons coated using ceramic, fiberglass, materials based on cellulose, or mixtures of the above-mentioned materials are suitable as the material for separator 24. Preferred materials for separator 24 are polyethylene and polypropylene.

Furthermore, each cell 12 includes an electrolyte 26, which preferably completely fills up anode chamber 20 and cathode chamber 22. Electrolyte 26 is at least situated between anode 14 or cathode 16 and separator 24, whereby it allows a current flow from anode 14 to cathode 16. Electrolyte 26 is implemented according to the present invention as a fluid. Electrolyte 26 is particularly preferably liquid. In general, electrolyte 26 includes a solvent having a high electricity constant, in order to be able to dissolve salts well, and having the lowest possible viscosity, in order to make the ion transport easier. Furthermore, electrolyte 26 typically includes a salt, which is dissolved in dissociated form in the solvent. Suitable solvents are, for example, ethylene carbonate, methyl formate, diethyl carbonate, ethyl acetate, methyl butyrate, ethyl butyrate, and greatly varying esters, such as tetrahydrofuran, and derivatives thereof. For example, lithium hexafluorophosphate (LiPF₆), lithium bis(oxalate) borate (BOB), or lithium tetrafluoroborate (LiBF₄) are suitable as the salt for the electrolyte.

Energy storage 11 or cell 12 further has a first opening 28 in anode chamber 20 and a second opening 30 in cathode chamber 22. Both openings 28, 30 are connected to one another by a connector 32, which preferably runs outside energy storage 11. Electrolyte 26 may be conveyed in a circuit through energy storage 11 by connector 32. Openings 28, 30 are therefore used as terminals for connector 32.

First opening 28 in anode chamber 20 may therefore be used as an inlet for electrolyte 26, while in contrast second opening 30 in cathode chamber 22 is used as an outlet. Of course, an inverse circuit is also possible. A pump 34 is preferably situated in connector 32 to convey electrolyte 26.

Furthermore, one functional unit 36 or multiple functional units 36 may additionally be provided, which are preferably situated in connector 32 or fluidically connected thereto. In alternative specific embodiments, only one or an arbitrary combination of functional units 36, which are only mentioned as examples hereafter, may be provided in each case.

For example, the at least one functional unit 36 may include a closure device for closing connector 32, which particularly preferably regulates the flow of electrolyte 26 in one direction and therefore in a circuit from cell 12 or energy storage 11, through connector 32, and back into cell 12 or into energy storage 11.

Furthermore, an analysis unit, such as a spectrometer, in particular a UV-visual spectrometer or an IR spectrometer, may be provided as functional unit 36, to study the composition and/or the properties of electrolyte 26. To remove possibly occurring gas bubbles from the interior of cell 12, functional unit 36 may further include a gas separator or also an opening, which is closable airtight, in particular for introducing and/or discharging at least one substance.

In addition, functional unit 36 may further preferably include a temperature control unit, with the aid of which the electrolyte may be kept at a preferred temperature.

In a particularly preferred specific embodiment, functional unit 36 includes a control unit, which is connected to at least one further functional unit 36. In addition, the control unit is preferably connected to a sensor or multiple sensors, such as a pressure sensor or a temperature sensor. In this way, for example, the temperature of electrolyte 26 may always be kept constant or at a desired value. Furthermore, if an unforeseen state occurs, the user may be warned or energy storage 11 may be deenergized, so that a danger to the user is reduced still further. In addition, for example, if the control unit is connected to the analysis unit, procedures running in cell 12 may be reacted to automatically. In this way, energy storage 11 may always operate optimally without an intervention by the user.

Energy storage 11 advantageously has an electrical terminal 38, which typically includes two terminal poles, as the electrical terminal for powering an electrical consumer.

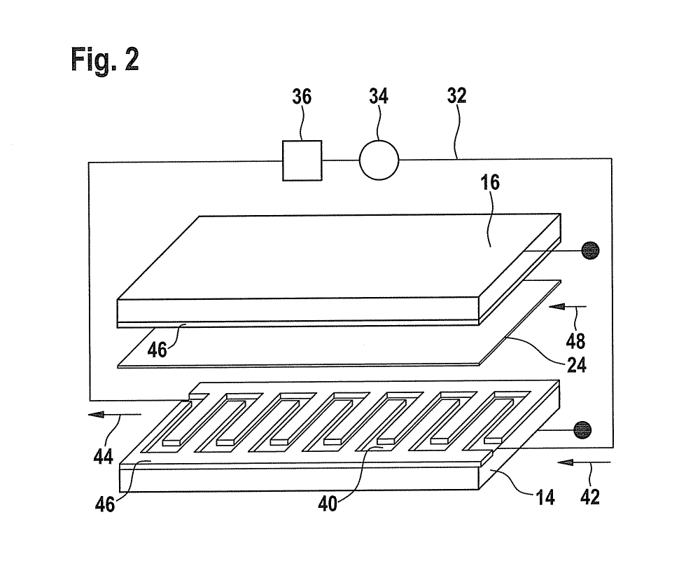

FIG. 2 shows anode 14 of energy storage 11, which is separated from cathode 16 by separator 24. Furthermore, connector 32 is schematically shown, in which electrolyte 26 may flow in a circuit. Housing 18 and both openings 28, 30 are not shown here for simplification. In order that it is possible to convey electrolyte 26 while simultaneously preferably having complete contact of electrolyte 26 with the electrodes, at least one, preferably multiple channels 40 are provided for the targeted guiding of electrolyte 26, through which electrolyte 26 is guided, for example, in the direction of arrows 42, 44 along the electrodes and separator 24.

The at least one channel 40 may be formed by a delimitation made of comb-like intermeshing structures, which is situated on the surface of anode 14, cathode 16, and/or separator 24. The channel may preferably be situated in an active material 46 of anode 14 and cathode 16. Suitable active materials 46 include, for example, on the anode side, carbon-based intercalation compounds with lithium, alloys of lithium, and alloys of lithium in carbon composites. On the cathode side, suitable active materials are typical transition metal oxides, for example, lithium cobalt oxide, lithium nickel oxide, lithium manganese oxide, and mixtures thereof. Furthermore, it is alternatively or additionally possible to situate the at least one channel 40 on both sides of separator 24. It is thus also possible to guide electrolyte 26 along arrow 48.

Independently of the positioning or the design and orientation of channel 40 or channels 40, a shape of channel 40 is preferred which allows the largest possible contact between electrolyte 26 and the electrodes and separator 24. Further possible shapes are, for example, circular or curved paths.

What is claimed is:

1. An electrical system comprising:
a connector; and
an energy storage which has at least one cell having an anode, a cathode, and a fluid electrolyte, the electrolyte allowing a current flow from the anode to the cathode, the cell having at least two openings, the openings being connected by the connector for a circulatory conveyance of the electrolyte.

2. The system according to claim 1, wherein the connector is situated outside the energy storage.

3. The system according to claim 1, wherein the connector is fluidically connected to a pump for conveying the electrolyte.

4. The system according to claim 1, wherein a closure device for closing the connector is situated in the connector.

5. The system according to claim 1, wherein the connector is fluidically connected to an opening, which is closable airtight, for introducing and/or discharging at least one substance.

6. The system according to claim 1, wherein the connector is fluidically connected to an analysis unit.

7. The system according to claim 1, wherein the connector is fluidically connected to a gas separator.

8. The system according to claim 1, wherein the system has a temperature control unit for temperature control of the electrolyte.

9. The system according to claim 1, wherein at least one channel is situated in the cell for a targeted guiding of the electrolyte.

10. The system according to claim 9, wherein the channel is formed by a delimitation made of comb-like intermeshing structures, which is situated on a surface of at least one of the anode, the cathode, and a separator.

11. The system according to claim 1, wherein the energy storage is an electrochemical energy storage.
